(19) United States
(12) Patent Application Publication
(10) Pub. No.: US 2024/0206607 A1
(43) Pub. Date: Jun. 27, 2024

(54) METHOD FOR COATING AN EXTERNAL PART, IN PARTICULAR IN THE HOROLOGICAL FIELD, AND COATED EXTERNAL PART

(71) Applicant: The Swatch Group Research and Development Ltd, Marin (CH)

(72) Inventors: Nicolas FRANÇOIS, Neuchâtel (CH); Margarita LESIK, Nyon (CH); Ahmad ODEH, Renens (CH)

(73) Assignee: The Swatch Group Research and Development Ltd, Marin (CH)

(21) Appl. No.: 18/527,782

(22) Filed: Dec. 4, 2023

(30) Foreign Application Priority Data
Dec. 22, 2022 (EP) 22216156.4

(51) Int. Cl. A44C 27/00; G04B 19/12; G04D 3/00

(52) U.S. Cl. CPC A44C 27/007; G04B 19/12; G04D 3/0092

(57) ABSTRACT

A method for coating an external part (1) used in the horology, fashion, jewellery and gemstone jewellery fields, the coating method comprising the steps of at least partially overmoulding the external part (1) with an overmoulding layer (4) made of a plastic polymer material selected from the group consisting of thermoplastic polymers of the polyurethane family and thermosetting polymers of the epoxy polymer family, or from the group consisting of thermoplastic acrylic resins.

### CROSS-REFERENCE TO RELATED APPLICATIONS

This application claims priority to European Patent Application No. 22216156.4 filed Dec. 22, 2022, the entire contents of which are incorporated herein by reference.

### TECHNICAL FIELD OF THE INVENTION

The present invention relates to a method for coating an external part used in the horology, fashion, jewellery and gemstone jewellery fields.

### TECHNOLOGICAL BACKGROUND

The present invention relates to the field of external parts used in the horology, fashion, jewellery and gemstone jewellery fields.

In the description below, the term “fashion item” will be understood to mean clothing items and accessories such as belts, footwear, and garments, as well as eyewear, electronic equipment, for example telephones, and any other decorative object.

Moreover, the term “external part” is commonly used in the aforementioned fields to designate a component visible to a user and having a decorative function, i.e. contributing to the visual appearance of an object.

In the particular field of horology, one well-known category of external parts is that of watch dials, above which in particular the hands displaying the current time move, and which are often fitted with technical components such as hour symbols, sometimes formed by brilliants, or decorative components, such as the logotype of the watch brand.

These dials are very expensive and also particularly fragile. However, dials of this kind are subject to a great deal of handling during manufacture and when they are fitted into watch cases. As a result, there is a high risk of these dials becoming deteriorated and having to be scrapped, which is difficult to accept from an economic point of view.

There was thus a need in the prior art to protect any type of external part in the horology, fashion, jewellery and gemstone jewellery fields against damage that could be caused thereto during manufacture and assembly.

### SUMMARY OF THE INVENTION

The aim of the present invention is to overcome the aforementioned drawbacks as well as others by proposing a method for coating external parts in the horology, fashion, jewellery and gemstone jewellery fields, guaranteeing effective mechanical protection of these external parts against the external mechanical stresses to which they may be subjected, particularly during production and during assembly of the watches.

To this end, the present invention relates to a method for coating an external part used in the horology, fashion, jewellery and gemstone jewellery fields, this coating method comprising the steps of:
at least partially overmoulding the external part with an overmoulding layer made of a plastic polymer material selected from the group consisting of thermoplastic polymers of the polyurethane family and thermosetting polymers of the epoxy polymer family, or from the group consisting of thermoplastic acrylic resins.

According to a special embodiment of the invention, the method further comprises the step of replicating a pattern in the overmoulding layer with which the external part is at least partially overmoulded.

According to another special embodiment of the invention, the step of at least partially overmoulding the external part is carried out by moulding or injecting the plastic polymer material.

According to yet another special embodiment of the invention, the at least partial overmoulding of the external part comprises the steps of:
placing the external part in a mould which encloses the pattern to be replicated in the overmoulding layer with which the external part is at least partially overmoulded;
closing the mould;
injecting the plastic polymer material into the mould so that it forms the overmoulding layer which at least partially overmoulds the external part and so that the pattern is replicated in this overmoulding layer simultaneously;
opening the mould and removing the overmoulded external part therefrom.

According to yet another special embodiment of the invention, the mould is made of a silicone material or a metallic or ceramic material.

According to yet another special embodiment of the invention, when a mould is made of a silicone material, this silicone mould which encloses the pattern intended to be replicated in the overmoulding layer is made by means of a master mould which is a positive mould carrying the pattern intended to be replicated in the overmoulding layer.

According to yet another special embodiment of the invention, when a mould is made of a silicone, metallic or ceramic material, the pattern enclosed in this metallic or ceramic mould and which is intended to be replicated in the overmoulding layer is produced using a laser beam device by means whereof the pattern intended to be replicated in the overmoulding layer is produced as a negative in the metallic or ceramic mould.

According to yet another special embodiment of the invention, the step of at least partially overmoulding the external part consists in coating the external part with an overmoulding layer formed by spraying this external part with the plastic polymer material, then in hot replicating the pattern in the overmoulding layer by means of a tool made using a laser beam device and carrying a negative of the pattern to be replicated in the overmoulding layer.

According to yet another special embodiment of the invention, the overmoulding layer is obtained by depositing the plastic polymer material in one or more successive applications.

According to yet another special embodiment of the invention, the thickness of the overmoulding layer is equal to 100 μm to within plus or minus 10%.

According to yet another special embodiment of the invention, the laser beam device used to produce the pattern comprises a laser beam emitting a coherent light beam with short pulses in the nanosecond range or with ultra-short pulses in the picosecond to femtosecond range.

According to yet another special embodiment of the invention, the laser beam emits pulses with an adjustable duration of between 4 ns and 350 ns, at a frequency of between 10 kHz and 1 MHz, and with a power equal to or close to 40 W.

According to yet another special embodiment of the invention, when the laser beam emits ultra-short pulses, the pulse frequency is between 100 kHz and 100 MHz.

According to yet another special embodiment of the invention, the overmoulding layer plays a technical role of providing mechanical protection and, where appropriate, a decorative role.

According to yet another special embodiment of the invention, the overmoulding layer comprises 78 wt. % plastic polymer, 15 wt. % carbon black colouring agent, 5 wt. % graphene and 2 wt. % coupling agent to promote the adhesion of the overmoulding layer to the external part.

According to yet another special embodiment of the invention, the overmoulding layer comprises 30 wt. % thermoplastic acrylic resin, and 60 wt. % of a solvent to which 1 wt. % of a dispersing agent, 8 wt. % of a black colouring agent and 1 wt. % of a coupling agent are added to promote the adhesion of the overmoulding layer to the external part.

According to yet another special embodiment of the invention, the coupling agent is silane.

According to yet another special embodiment of the invention, the black colouring agent has a lightness value measured colourimetrically of less than or equal to 10.

According to yet another special embodiment of the invention, the black colouring agent is composed of 95 wt. % carbon black and 5 wt. % graphene.

The invention further relates to an external part in the horology, fashion, jewellery and gemstone jewellery fields, this external part being at least partially coated with an overmoulding layer made of a plastic polymer material selected from the group consisting of thermoplastic polymers of the polyurethane family and thermosetting polymers of the epoxy polymer family, or from the group consisting of thermoplastic acrylic resins.

According to a particular embodiment of the invention, the overmoulding layer comprises the replication of a decorative and/or technical pattern.

According to another embodiment of the invention, the overmoulding layer is formed by one or more plastic polymer layers.

According to yet another embodiment of the invention, the thickness of the overmoulding layer is equal to 100 μm to within plus or minus 10%.

According to yet another embodiment of the invention, the overmoulding layer comprises 78 wt. % plastic polymer, 15 wt. % carbon black colouring agent, 5 wt. % graphene and 2 wt. % coupling agent to promote the adhesion of the overmoulding layer to the external part.

According to yet another embodiment of the invention, the overmoulding layer comprises 30 wt. % thermoplastic acrylic resin, and 60 wt. % of a solvent to which 1 wt. % of a dispersing agent, 8 wt. % of a black colouring agent and 1 wt. % of a coupling agent are added to promote the adhesion of the overmoulding layer to the external part.

According to yet another embodiment of the invention, the coupling agent is silane.

According to yet another embodiment of the invention, the black colouring agent has a lightness value measured colourimetrically of less than or equal to 10.

According to yet another embodiment of the invention, the black colouring agent is composed of 95 wt. % carbon black and 5 wt. % graphene.

Thanks to these features, the present invention provides a method for coating an external part in the horology, fashion, jewellery and gemstone jewellery fields, which method, by disclosing the at least partial overmoulding of the external part with an overmoulding layer made of a plastic polymer material, allows such an external part to be protected against the damage that may be caused thereto during manufacture and assembly.

According to another advantage of the present invention, overmoulding the external part with a layer of plastic polymer material is easy to implement, either by spraying a succession of thin layers of the plastic polymer material, or by injecting the plastic polymer material into a mould by injection moulding.

According to yet another advantage of the present invention, the overmoulding layer with which the external part is coated also contributes to decorating this external part, in particular by reproducing the imprint of a pattern in this overmoulding layer and, where desired, by giving this overmoulding layer a particular appearance, for example a matt appearance, or a particular colour, for example a deep black colour. The overmoulding layer thus advantageously has two functions: a function for ensuring the mechanical protection of and a function for decorating the external part on which it is overmoulded.

### BRIEF DESCRIPTION OF THE FIGURES

Other features and advantages of the present invention will appear more clearly upon reading the following detailed description given of one example implementation of the method according to the invention, said example being provided for illustrative purposes only and not intended to limit the scope of the invention, with reference to the accompanying drawing, wherein:

FIG. 1 is a perspective view of a dial-type external part for a timepiece coated with an overmoulding layer;

FIG. 2A is a diagrammatic view illustrating the step of overmoulding the external part by spraying a plastic polymer material;

FIG. 2B is a diagrammatic view illustrating the step of hot replication of a pattern in the overmoulding layer by means of a tool made using a laser beam device and which carries a negative of the pattern to be overmoulded in the overmoulding layer;

FIG. 3 is a diagrammatic view illustrating the step of overmoulding and replicating the pattern by injecting a plastic polymer material into a mould;

FIG. 4 is a diagrammatic view illustrating a first method for manufacturing a mould enclosing the pattern intended to be replicated in the overmoulding layer which at least partially surrounds the external part;

FIG. 5 is a diagrammatic view illustrating a second method for manufacturing a mould enclosing the pattern intended to be replicated in the overmoulding layer which at least partially surrounds the external part.

### DETAILED DESCRIPTION OF THE INVENTION

The present invention was drawn from the general inventive idea consisting of coating any type of external part in the horology, fashion, jewellery and gemstone jewellery fields with an overmoulding layer made of a plastic polymer material, thus allowing such an external part to be protected against the damage that may be caused thereto during manufacture and assembly. According to another aspect hereof, the present invention further proposes using the overmoulding layer to decorate the external part coated with this overmoulding layer. In particular, this layer is intended to be given a particular colour, for example a deep black or a reflective white colour. The overmoulding layer according to the invention thus has two functions: a mechanical protection function and a function for decorating the external part. These two functions are carried out by the same overmoulding layer, which is very easily deposited by spraying thin layers of the plastic polymer material, or by injecting the plastic polymer material into a mould.

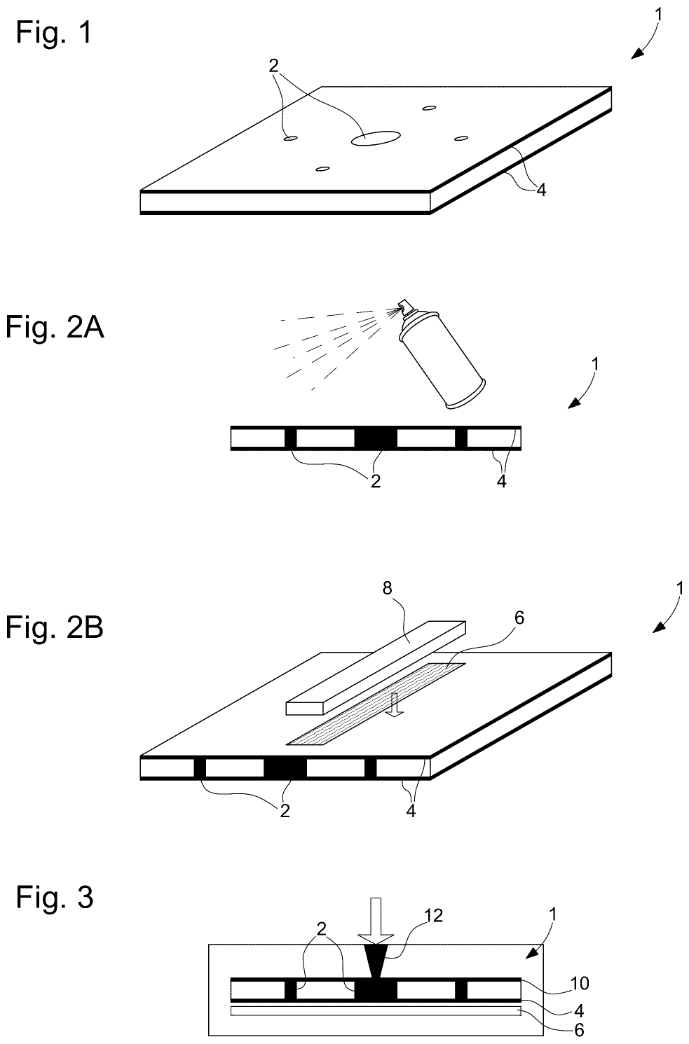

In the following description, it will be assumed, by way of example for illustrative, non-limiting purposes only, that the external part is a dial for a timepiece such as a wristwatch. Denoted as a whole by the general reference numeral 1, this dial is provided with a plurality of holes 2, in particular to allow the arbors of the hour and minute hands (not shown) to pass in order to display the current time, as well as to allow, for example, appliques to be attached in order to form the hour symbols (see FIG. 1).

According to the invention, this dial 1 is at least partially coated with an overmoulding layer 4 made of a plastic polymer material selected from the group consisting of thermoplastic polymers of the polyurethane family and thermosetting polymers of the epoxy polymer family, or from the group consisting of thermoplastic acrylic resins.

The overmoulding layer 4 plays a technical role of providing mechanical protection. The presence of this overmoulding layer 4 can also be used to replicate a pattern 6 for purely decorative or also technical purposes (reproduction of the logotype of the brand of the timepiece, for example). In addition to the appearance of the pattern 6 replicated in the overmoulding layer 4, the colour of the overmoulding layer 4 can also be varied.

According to a special implementation of the invention, the overmoulding layer 4 comprises 78 wt. % plastic polymer, 15 wt. % carbon black colouring agent, 5 wt. % graphene and 2 wt. % coupling agent to promote the adhesion of the overmoulding layer 4 to the external part 1.

According to another special embodiment of the invention, the overmoulding layer 4 comprises 30 wt. % thermoplastic acrylic resin, and 60 wt. % of a solvent to which 1 wt. % of a dispersing agent, 8 wt. % of a black colouring agent and 1 wt. % of a coupling agent are added to promote the adhesion of the overmoulding layer 4 to the external part 1.

The coupling agent is, for example, silane. The black colouring agent is composed of 95 wt. % carbon black and 5 wt. % graphene. The black colouring agent preferably has a lightness value measured colourimetrically of less than or equal to 10.

According to a first implementation of the method of the invention illustrated in FIG. 2A, the step of overmoulding the external part 1 consists of coating the external part 1 with an overmoulding layer 4 formed by spraying this external part 1 with the plastic polymer material. This overmoulding layer 4 is obtained by depositing the plastic polymer material in one or more successive applications. The thickness of the overmoulding layer 4 is equal to 100 μm to within plus or minus 10%. Overmoulded in this way, the external part 1 is protected against the risks of deterioration that may occur during manufacture and assembly, for example in watch cases when the external part is a dial.

The presence of the overmoulding layer 4, initially intended to protect the external parts 1 against the risks of deterioration, can also be used to produce a three-dimensional pattern in this overmoulding layer 4, the function of which pattern can be purely decorative or technical (for example reproducing the logotype of the brand of the timepiece in the thickness of the overmoulding layer 4). For this reason, as diagrammatically shown in FIG. 2B, once the external part 1 has been coated, a pattern 6 is hot-replicated in the overmoulding layer 4 by means of a tool 8 of the stamp type which can, for example, be produced using a laser beam device and which carries a negative of the pattern 6 to be replicated in the overmoulding layer 4.

According to a second implementation of the method of the invention illustrated in FIG. 3, the step of at least partially overmoulding the external part 1 comprises the steps of:
placing the external part 1 in a mould 10 which encloses the pattern 6 to be replicated in the overmoulding layer 4 with which the external part 1 is at least partially overmoulded;
closing the mould 10;
injecting the plastic polymer material into the mould 10 via an injection channel 12 so that it forms the overmoulding layer 4 which at least partially overmoulds the external part 1 and so that the pattern 6 is replicated in this overmoulding layer 4 simultaneously;
opening the mould 10 and removing the overmoulded external part 1 therefrom.

The mould 10 can be made either of a silicone material or of a metallic or ceramic material. Silicone moulds are more particularly reserved for use in the manufacture, by moulding, of small series of overmoulded external parts 1, whereas a metallic or ceramic mould is preferred in the manufacture, by injection moulding, of large series of overmoulded external parts 1.

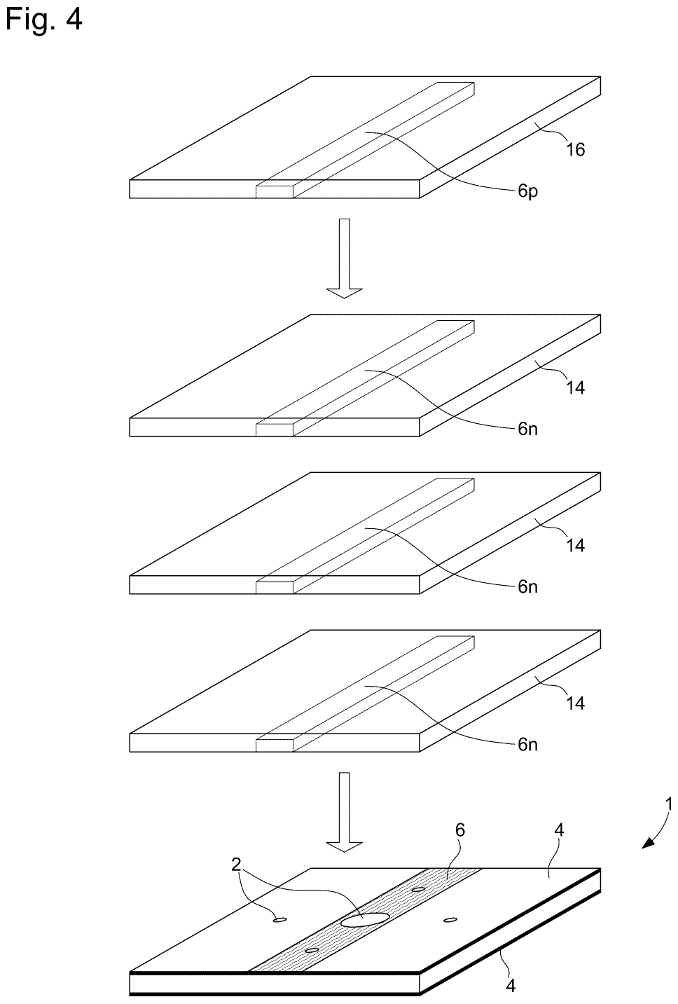

When the mould 10 is made of a silicone material as shown in FIG. 4, this silicone mould 14 is often made in several copies from a master mould 16. The pattern 6 enclosed within this master mould 16 can be produced, for example, using a laser beam device. This pattern 6p is intended to be replicated in the silicone mould 14 and corresponds to the positive of the pattern 6 to be replicated in the overmoulding layer 4. The external part 1 is overmoulded by moulding this external part 1 in a silicone mould.

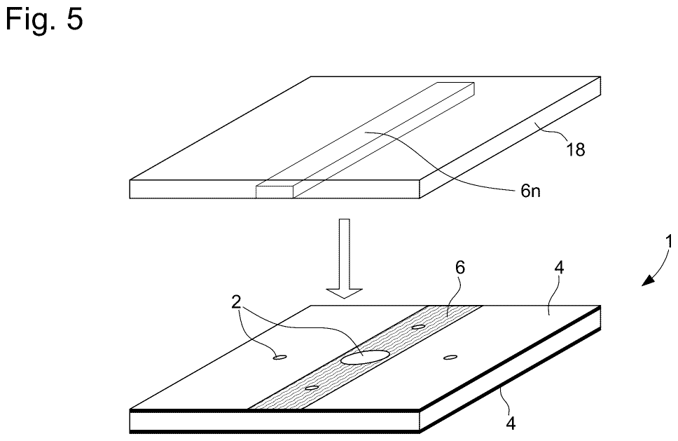

When the mould 10 is made of a metallic or ceramic material, the pattern 6 enclosed in the metallic mould 18 and which is intended to be directly replicated in the overmoulding layer 4 is produced, for example, using a laser beam device by means whereof the pattern 6n intended to be replicated in the overmoulding layer 4 is produced as a negative within an inner wall of the metallic mould 18 (see FIG. 5).

The laser beam device used to produce the pattern 6 inside the metal mould 18 comprises a laser beam emitting a coherent light beam with short pulses in the nanosecond range or with ultra-short pulses in the picosecond to femtosecond range.

The laser beam emits pulses with an adjustable duration of between 4 ns and 350 ns, at a frequency of between 10 kHz and 1 MHz, and with a power equal to or close to 40 W.

When the laser beam emits ultra-short pulses, the pulse frequency is between 100 kHz and 100 MHz.

It goes without saying that the present invention is not limited to the implementation described hereinabove and that various simple alternatives and modifications can be considered without leaving the scope of the invention as defined by the accompanying claims. In particular, it should be noted that if the external part is a watch dial, the edge of this watch dial is preferably not coated by the overmoulding layer 4, in order to make it easier to fit this watch dial inside the watch case. More generally, when overmoulding a given external part, steps can be taken to ensure that certain surfaces of this external part are not coated by the overmoulding layer. It should also be noted that, when the method of the invention is applied to external parts intended to come into contact with a user's skin, the overmoulded layer provides a high level of comfort when worn.

### NOMENCLATURE

1. External part
2. Holes
4. Overmoulding layer
6. Pattern
6p. Positive pattern
6n. Negative pattern
8. Tool
10. Mould
12. Injection channel
14. Silicone mould
16. Master mould
18. Metallic mould

1. A method for coating an external part (1) used in the horology, fashion, jewellery and gemstone jewellery fields, the coating method comprising the steps of:
at least partially overmoulding the external part (1) with an overmoulding layer (4) made of a plastic polymer material selected from the group consisting of thermoplastic polymers of the polyurethane family and thermosetting polymers of the epoxy polymer family, or from the group consisting of thermoplastic acrylic resins.

2. The method for coating an external part according to claim 1, wherein the method further comprises the step of replicating a pattern (6) in the overmoulding layer (4) with which the external part (1) is at least partially overmoulded.

3. The method for coating an external part according to claim 2, wherein the step of at least partially overmoulding the external part (1) is carried out by moulding or injecting the plastic polymer material.

4. The method for coating an external part according to claim 3, wherein at least partially overmoulding the external part (1) comprises the steps of:
placing the external part (1) in a mould which encloses the pattern to be replicated in the overmoulding layer (4) with which the external part (1) is at least partially overmoulded;
closing the mould;
injecting the plastic polymer material into the mould so that it forms the overmoulding layer (4) which at least partially overmoulds the external part (1) and so that the pattern is replicated in the overmoulding layer (4) simultaneously;
opening the mould and removing the overmoulded external part (1) therefrom.

5. The method for coating an external part according to claim 4, wherein the mould is made either of a silicone material or of a metallic or ceramic material.

6. The method for coating an external part according to claim 5, wherein when a mould is made of a silicone material, the silicone mould (14) which encloses the pattern (6) intended to be replicated in the overmoulding layer (4) is made by means of a master mould (16) which is a positive mould carrying the pattern (6) intended to be replicated in the overmoulding layer (4).

7. The method for coating an external part according to claim 5, wherein when a mould is made of a silicone, metallic or ceramic material, the pattern (6) enclosed in the metallic or ceramic mould (18) and which is intended to be replicated in the overmoulding layer (4) is produced using a laser beam device by means whereof the pattern (6) intended to be replicated in the overmoulding layer (4) is produced as a negative in the metallic or ceramic mould (18).

8. The method for coating an external part according to claim 2, wherein the step of at least partially overmoulding the external part (1) consists in coating the external part (1) with an overmoulding layer (4) formed by spraying the external part (1) with the plastic polymer material, then in hot replicating the pattern (6) in the overmoulding layer (4) by means of a tool made using a laser beam device and carrying a negative of the pattern (6) to be replicated in the overmoulding layer (4).

9. The method for coating an external part according to claim 8, wherein the overmoulding layer (4) is obtained by depositing the plastic polymer material in one or more successive applications.

10. The method for coating an external part according to claim 9, wherein the thickness of the overmoulding layer (4) is equal to 100 μm to within plus or minus 10%.

11. The method for coating an external part according to claim 7, wherein the laser beam device used to produce the pattern (6) comprises a laser beam emitting a coherent light beam with short pulses in the nanosecond range or with ultra-short pulses in the picosecond to femtosecond range.

12. The method for coating an external part according to claim 11, wherein the laser beam emits pulses with an adjustable duration of between 4 ns and 350 ns, at a frequency of between 10 kHz and 1 MHz, and with a power equal to or close to 40 W.

13. The method for coating an external part according to claim 11, wherein when the laser beam emits ultra-short pulses, the pulse frequency is between 100 kHz and 100 MHz.

14. The method for coating an external part according to claim 2, wherein the overmoulding layer (4) plays a technical role of providing mechanical protection and a decorative role where appropriate.

15. The method for coating an external part according to claim 14, wherein the overmoulding layer (4) comprises 78 wt. % plastic polymer, 15 wt. % carbon black colouring agent, 5 wt. % graphene and 2 wt. % coupling agent to promote the adhesion of the overmoulding layer (4) to the external part (1).

16. The method for coating an external part according to claim 14, wherein the overmoulding layer (4) comprises 30 wt. % thermoplastic acrylic resin, and 60 wt. % of a solvent to which 1 wt. % of a dispersing agent, 8 wt. % of a black colouring agent and 1 wt. % of a coupling agent are added to promote the adhesion of the overmoulding layer (4) to the external part (1).

17. The method for coating an external part according to claim 15, wherein the coupling agent is silane.

18. The method for coating an external part according to claim 16, wherein the black colouring agent has a lightness value measured colourimetrically of less than or equal to 10.

19. The method for coating an external part according to claim 18, wherein the black colouring agent is composed of 95 wt. % carbon black and 5 wt. % graphene.

20. An external part (1) in the horology, fashion, jewellery and gemstone jewellery fields, the external part (1) being at least partially coated with an overmoulding layer (4) made of a plastic polymer material selected from the group consisting of thermoplastic polymers of the polyurethane family and thermosetting polymers of the epoxy polymer family, or from the group consisting of thermoplastic acrylic resins.

21. The external part (1) according to claim 20, wherein the overmoulding layer (4) comprises the replication of a decorative and/or technical pattern (6).

22. The external part (1) according to claim 20, wherein the overmoulding layer (4) is formed by one or more plastic polymer layers.

23. The external part (1) according to claim 22, wherein the thickness of the overmoulding layer (4) is equal to 100 μm to within plus or minus 10%.

24. The external part (1) according to claim 23, wherein the overmoulding layer (4) comprises 78 wt. % plastic polymer, 15 wt. % carbon black colouring agent, 5 wt. % graphene and 2 wt. % coupling agent to promote the adhesion of the overmoulding layer (4) to the external part (1).

25. The external part (1) according to claim 23, wherein the overmoulding layer (4) comprises 30 wt. % thermoplastic acrylic resin, and 60 wt. % of a solvent to which 1 wt. % of a dispersing agent, 8 wt. % of a black colouring agent and 1 wt. % of a coupling agent are added to promote the adhesion of the overmoulding layer (4) to the external part (1).

26. The external part (1) according to claim 24, wherein the coupling agent is silane.

27. The external part (1) according to claim 24, wherein the black colouring agent has a lightness value measured colourimetrically of less than or equal to 10.

28. The external part (1) according to claim 27, wherein the black colouring agent is composed of 95 wt. % carbon black and 5 wt. % graphene.
